(19) United States
(12) Patent Application Publication
(10) Pub. No.: US 2026/0366963 A1
(43) Pub. Date: Nov. 19, 2026

(54) Sonic Sediment Sampler

(71) Applicants: James JJ Henderson, Charlotte, NC (US); Fábio Marcellino de Oliveira, Mogi Mirim (BR); Ruy de Oliveira Silva, Camaçari (BR); Sergio Luis Correa Ferreira, Salvador (BR)

(72) Inventors: James JJ Henderson, Charlotte, NC (US); Fábio Marcellino de Oliveira, Mogi Mirim (BR); Ruy de Oliveira Silva, Camaçari (BR); Sergio Luis Correa Ferreira, Salvador (BR)

(21) Appl. No.: 19/211,206

(22) Filed: May 18, 2025

(51) Int. Cl. G01N 1/10

(52) U.S. Cl. CPC G01N 1/10

(57) ABSTRACT

A remotely controlled, drone-deployable sediment sampling device is disclosed. The device comprises an aluminum sediment sampler, a vibration-generating sonic head, a support tripod, a float and suspension system, and a radio controller. The system allows for collection of sediment samples without direct human contact with contaminated water bodies. The sonic head enables efficient penetration of sediment beds, and remote operation facilitates deployment in inaccessible or hazardous environments. The device reduces environmental disturbance and personnel risk, offering a sustainable, accurate alternative to conventional sampling methods.

### CROSS-REFERENCE RELATED APPLICATIONS

This application claims the benefit of U.S. Provisional Application No. 63/649,399, filed on May 19, 2024, under 35 U.S.C. § 119(e). The contents of the provisional application are incorporated herein by reference.

### FIELD OF THE INVENTION

The present invention relates to environmental sampling devices, and more particularly to an unmanned aerial vehicle (UAV)-deployable sediment sampling system incorporating a remotely operated sonic vibration head.

### BACKGROUND OF THE INVENTION

Contaminated water bodies resulting from anthropogenic activities pose a risk to environmental and public health. Effective sediment sampling is necessary to assess and remediate contamination. Conventional sampling methods require manual operation over water using boats or dredges, exposing workers to hazardous conditions and risking disturbance of sediments. These methods are labor-intensive, often imprecise, and may inadvertently release contaminants.

### SUMMARY OF THE INVENTION

The invention consists of a remotely operated sediment sampling device that is drone-deployable and powered by a vibrating sonic head to drive the sampler into the sediment bed. It minimizes risk to personnel, is emission-free, and enables sampling in remote or hazardous locations without disturbing the surrounding environment. The SSS is less than one kilogram in weight and can be operated via any small drone. It offers enhanced precision, safety, and adaptability compared to traditional methods of sediment sampling.

### BRIEF DESCRIPTION OF THE DRAWINGS

FIG. 1 shows the aluminum sampler compartments.

FIG. 2 shows the PVC tripod and assembled sampler.

FIG. 3 illustrates the internal components of the sonic head.

FIG. 4 depicts the suspension cord and float system.

### DETAILED DESCRIPTION OF THE INVENTION

The Sonic Sediment Sampler (SSS) was designed to be deployed by an Unmanned Aerial Vehicle (UAV), more commonly referred to as a “drone”. The SSS is comprised of the following components: 1) aluminum sample retriever with a swing check valve; 2) vibrating sonic head affixed to the top of the sample retriever; 3) stabilization PVC tripod; 4) suspension cord with float, and 5) radio controller that operates the sampler. The SSS is independent of the drone and its operation; it only needs to be connected via the cord to the drone undercarriage and receive power. The aluminum sample retriever is a hollow aluminum tube that sinks into sediments under gravity and vibrational effects, forcing sediments into the tube. The swing check valve is located at the bottom of the sampler to prevent the sediment from falling out the bottom of the tube. The tripod is attached to the top of the sampler to keep the sampler up-right on top of the sediment layer at the bottom of the surface water body. The sonic head has a waterproof plastic housing attached to the aluminum tube and is equipped with a small brushless motor that spins at a high rate, causing the aluminum tube to vibrate and sink into sediments. The suspension cord and float are attached to the drone from a loop on the sonic head. The float has free movement up and down the suspension cord, depending on the depth of the sample. The radio controller is coded via radio frequency to start and stop vibration of the sonic head. Each component is described in detail below.

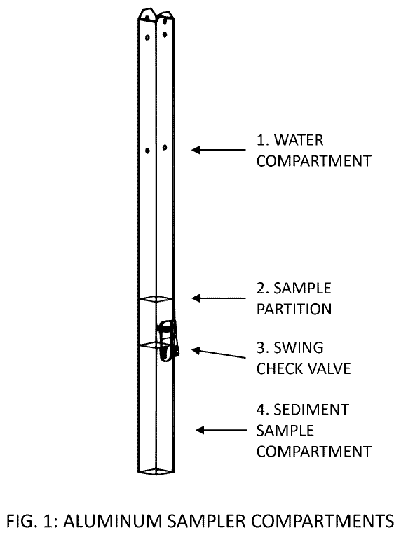

### Aluminum Sampler (FIG. 1)

The aluminum sampler is a square tube of 390 mm length and 25 mm width. The sampler has a maximum volume of solid sediment of 52.9 cm³ (dimensions: 100 mm×23 mm×23mm), and a maximum volume of liquid of 153 cm³ and an estimated weight of 705 grams. The added weight of the retrieved sample will vary depending on sediment type, moisture content and water. FIG. 1 shows a schematic of water and sediment sample compartments in the aluminum sampler housing. Water can be collected in the 2nd compartment. The total weight of the sampler and sample should not exceed 1.2 kg.

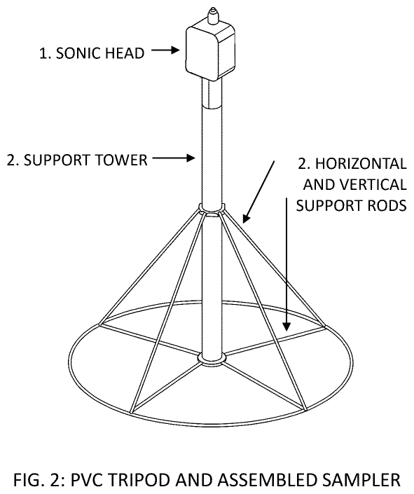

### PVC Tripod (FIG. 2)

A fiberglass support tower keeps the sonic head and sampler vertically aligned while collecting the sediment sample, but the tower is structural in nature and has no functional connection to the sampler itself, which resides inside the tower. (FIG. 2). When assembled the total weight of the sampler and tower is approximately 900 grams. The tripod is made of PVC tube and fiberglass rods.

The bottom measures 450 mm in diameter. Six horizontal and six vertical supports are connected to the support for the central tube containing the sampler. Together these structural elements provide a stable base as the sampler assembly sinks into the sediments, allowing the sampler to penetrate and retrieve the sample. The tripod is designed to limit the depth to which the sampler can penetrate the sediments. The total assembly requires a drone with a minimum payload rating of 6 kg.

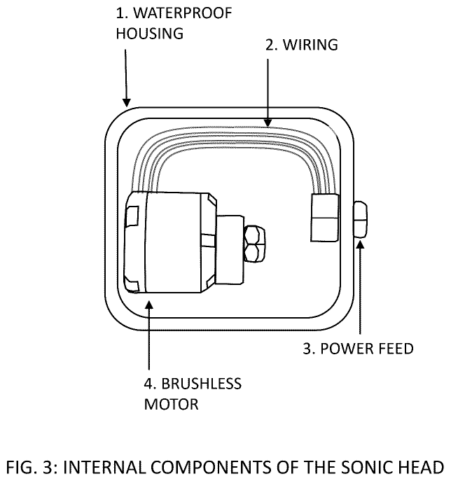

### Sonic Head (FIG. 3)

The sonic head is comprised of a brushless motor with a rating of 2212 920KV. The operational range of the motor is 1,780 to 11,592 revolutions-per-minute (RPM). The SSS is operated at up to 10,600 RPM, depending on the competency and depth of the sampled sediment lithology and its moisture content. A maximum of 10,600 RPM is set through the radio controller. A common RPM for standard sediments is 8,000 RPM.

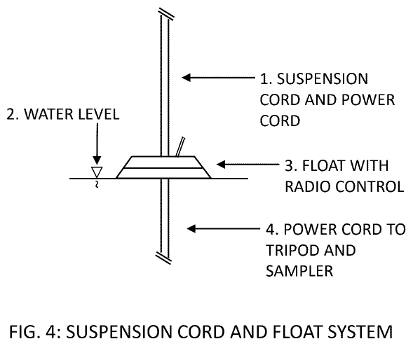

### Suspension Cord and Float System (FIG. 4)

A suspension cord made of PVC-coated steel cable is attached to a retractable hook on the undercarriage of the drone, with the other end attached to a loop on top of the sampler tower. The exact length of the cord will vary depending on the depth of the sample to be retrieved. The float is connected to the cord at the measured length from the top of the standing water column to the bottom of the expected sample interval in the sediment layer to be sampled. The float is also equipped with a watertight PVC housing that contains the battery that provides power to the sonic drill head. This box also contains the control module that communicates via radio link at 2.4 GHz with the radio controller. The float module has a guide hole in which the cord that attaches to the drone is threaded and attached to the top of the drill head. This ensures that the float can move freely on the water surface as the sampling device sinks to the surface water-sediment interface. The float module has an insulated watertight power cable that attaches to the sonic head and is adjustable in length based on the sampling conditions.

### Radio Controller

A radio controller containing an Arduino microcontroller, a Wireless Data Transmission Module NRF24L01 PA and a 3S LiPo Battery operates the Sonic Sediment Sampler. This radio unit allows the operator to link via 2.4 Ghz frequency to the sampler's remote unit and is independent of the operation of the drone. The controller has two switches, one to turn on the controller, and the other to power up the sampler. A potentiometer controls the RPM of the sonic head and the sampler's vibrational frequency. For most sediments the potentiometer can be operated at 60% frequency (between 9,000 and 9,500 RPM). The sampler should not be operated above this range for more than one minute, which is sufficient to penetrate shallow sample depths (~10 cm). The radio controller is connected to a remote unit on the sampler which must be powered up prior to sampler deployment by the drone. Both the local controller and the remote unit batteries need to be fully charged prior to operation.

What is claimed:

1. A sonic sediment sampling device comprised of the following:
a housing configured to be submerged in a body of water;
a sonic head mounted within the housing and operable to emit acoustic energy at the surface water-sediment interface for collection of sediment samples;
a swing check valve at the bottom of the housing that permits the sample to enter the tube, allowing water and air to escape the enclosure, and subsequently closes by vacuum when lifted from the sediment by the drone;
a remote-control system configured to operate the sonic head from a safe location adjacent to the surface water body.

2. The device of claim 1, wherein the remote-control system comprises a wireless transmitter and receiver.

3. The device of claim 1, further comprising a sediment collection chamber positioned to capture sediment.

4. The device of claim 3, wherein the sediment collection chamber is removably attached to the housing.

5. The device of claim 1, wherein the sonic head comprises a transducer configured to generate pulses in the ultrasonic frequency range.

6. The device of claim 1, wherein the remote-control system further controls the power level and duration of sonic emissions.
